(19) United States
(12) Patent Application Publication
(10) Pub. No.: US 2005/0195324 A1
(43) Pub. Date: Sep. 8, 2005

(54) Method of converting frame rate of video signal based on motion compensation

(75) Inventor: Hun Cheol Lee, Seoul (KR)

Correspondence Address: JONATHAN Y. KANG, ESQ;LEE, HONG, DEGERMAN,, KANG & SCHMADEKA, 801 S. Figueroa Street, 14th Floor, Los Angeles, CA, 90017, US

(73) Assignee: LG Electronics Inc.

(21) Appl. No.: 11/058,786

(22) Filed: Feb. 15, 2005

(30) Foreign Application Priority Data
Feb. 16, 2004 (KR) 10-2004-0010097

(51) Int. Cl. H04N 11/20

(52) U.S. Cl. 348/441

(57) ABSTRACT

There is provided a method of converting frame rate of video signal based on motion estimation, which is adapted to convert an arbitrary video signal into a video signal having higher frame rate than the arbitrary video signal. The method includes the steps of: estimating a plurality of motion vectors based on block unit with reference to a picture to be interpolated; and if a current pixel exists in a motion boundary according to a correlation between brightness values of pixels with respect to motion vectors based on pixel unit, classifying and interpolating the plurality of estimated motion vectors based on the block unit according to motion boundary region's.

This application claims the benefit of the Korean Application No. 10-2004-0010097, filed on Feb. 16, 2004 which is hereby incorporated by reference.

### BACKGROUND OF THE INVENTION

1. Field of the Invention

The present invention relates to a video signal processing, and more particularly, to a method of converting frame rate of video signal based on motion compensation, which is adapted to convert an arbitrary video signal into a video signal having a higher frame rate than the arbitrary video signal.

2. Discussion of the Related Art

For increasing frame rate, a new picture must be created from two pictures (frames) temporally adjacent to each other. This can be simply achieved by repeating a previous picture.

However, this method has a disadvantage in that motion may be seen discontinuously in a region where motion is large. Accordingly, temporal interpolation techniques using motion information have been developed.

Motion information in video sequence is used in various application fields, such as video signal compression, analysis, segmentation and enhancement.

Motion information is obtained through motion estimation. A method widely used includes a block matching motion estimation method and an optical flow estimation method based on a spatial-temporal gradient of a video signal.

Hereinafter, a motion vector estimation and interpolation method according to the prior art will be described with reference to the accompanying drawings.

FIG. 1 illustrates a motion vector estimation method according to the prior art and FIG. 2 illustrates a spatial interpolation method for motion vector in pixel unit according to the prior art.

A motion vector between two frames temporally adjacent to each other must be estimated so as to increase frame rate. A method shown in FIG. 1 is a motion vector estimation method based on block unit.

A method shown in FIG. 2 is a spatial interpolation method of estimating a motion vector based on pixel unit.

In FIG. 1, a motion vector is estimated from a current picture based on block unit with reference to a previous picture. A motion vector in each pixel of the current picture is estimated so as to interpolate a picture between the previous picture and the current picture.

A brightness value in a pixel where a locus of the motion vector and a picture to be interpolated are met is determined using a pixel of the current pixel and a pixel of the previous picture, which are connected by the motion vector.

In FIG. 1, an arrow indicated by a solid line represents a motion vector that is actually estimated, and an arrow indicated by a dotted line represents a motion vector that is spatially interpolated.

However, this method has a problem in that there may be missing pixels in the picture to be interpolated. Here, the missing pixels are pixels through which the motion vector does not pass, that is, pixels to which the brightness value is not assigned.

Meanwhile, the motion vector in each pixel of the current picture can be estimated by calculating motion vectors in all pixels. However, this method is difficult to implement in real time because it requires a large amount of calculation.

Accordingly, a motion vector is estimated based on block unit and the other pixels are calculated with reference to motion vectors of adjacent blocks.

Referring to FIG. 2, the current picture's pixels to which motion vector is not assigned are spatially interpolated using four adjacent block motion vectors. Pixels that belong to a region indicated by oblique lines are pixels that need to be spatially interpolated using four adjacent block motion vectors MV1, MV2, MV3 and MV4.

A simple method of spatially interpolating a motion vector is to assign a motion vector of an arbitrary block to all pixels that belong to the arbitrary block.

For example, the motion vector MV1 is assigned to a pixel p1 and the motion vector MV4 is assigned to a pixel p4. Then, a motion vector is interpolated at an arbitrary position by using four adjacent block motion vectors.

In this method, four adjacent block motion vectors MV1, MV2, MV3 and MV4 are used to calculate a motion vector at the pixel p1 and a bi-linear interpolation is performed using a distance between the pixel p1 and a center of each block. However, such an interpolation method uses only the motion vector, not information on adjacent brightness information. Therefore, a blurring of the motion vector that is interpolated may be caused in a vicinity of a region where a motion boundary exists. Consequently, a blurring may also be caused in a brightness value of a picture to be temporally interpolated.

### SUMMARY OF THE INVENTION

Accordingly, the present invention is directed to a method of converting frame rate of video signal based on motion estimation that substantially obviates one or more problems due to limitations and disadvantages of the prior art.

An object of the present invention is to provide a method of converting frame rate of video signal based on motion estimation, which is adapted to convert an arbitrary video signal into a video signal having higher frame rate than the arbitrary video signal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, method of converting frame rate of video signal based on motion compensation includes the steps of: estimating a plurality of motion vectors based on block unit with reference to a picture to be interpolated; and if a current pixel exists in a motion boundary according to a correlation between brightness values of pixels with respect to motion vectors based on pixel unit, classifying and interpolating the plurality of estimated motion vectors based on the block unit according to motion boundary regions.

The estimation of the plurality of motion vectors based on the block unit may include the steps of: selecting a candidate motion vector (CMV) passing through a representative pixel of the picture to be interpolated; making blocks centered on pixels where the candidate motion vector meets a current picture and a previous picture with reference to one axis of a two-dimensional video signal; calculating a difference in brightness values of pixels corresponding to the blocks; and assigning a candidate motion vector where the calculated difference is minimized as a block motion vector of the picture to be interpolated.

If a component of the candidate motion vector (CMV) is even, the calculation of the difference in the brightness values of the pixels may include the steps of: finding a candidate motion vector symmetrical to each other in the previous picture and the current picture with reference to a representative pixel of a corresponding block; and summing absolute values of the difference values of the pixels constituting the corresponding block.

If a component of the candidate motion vector (CMV) is odd, the calculation of the difference in the brightness values of the pixels may include the steps of: shifting a path of a candidate motion vector that does not pass through the representative pixel so as to make the candidate motion vector pass through the representative pixel; making blocks by linearly interpolating values between each pixels using adjacent pixels; and calculating a difference in brightness values of blocks of the current picture and the previous picture.

The candidate motion vector may be shifted by half pixel from the axis so as to make the candidate motion vector pass through the representative pixel.

If the correlation between the brightness values is larger than a reference value, it is determined that the brightness value of the corresponding region is uniform and a bi-linear interpolation is performed using motion vectors of the corresponding block.

If the correlation value between the brightness values is smaller than a reference value, a correlation between a plurality of motion vectors is calculated, and if the calculated correlation is larger than the reference value, it is determined that a brightness value of the corresponding region is uniform and a bi-linear interpolation is performed using motion vectors of the corresponding block.

If the calculated correlation is smaller than the reference value, the plurality of motion vectors are classified according to the motion boundary regions.

In the classification of the plurality of motion vectors, the block motion vectors are classified based on magnitudes and directions.

The method of claim 9 may include the steps of: determining the motion boundary after classifying the block motion vectors according to the motion boundary regions, based on the magnitudes and directions; and interpolating the motion vectors independently according to the determined motion boundary regions.

According to another aspect of the present invention, a method of converting frame rate based on motion compensation includes the steps of: calculating a variation of brightness values in pixels including representative pixels of blocks adjacent to a current pixel; if the calculated variation is larger than a reference value, calculating a correlation of block motion vectors in magnitudes and directions; if it is determined that there is a motion boundary in a corresponding region by the calculated correlation between the block motion vectors, classifying the block motion vectors in magnitudes and directions; and determining the motion boundary of the classified motion vectors and interpolating the motion vectors according to the corresponding region.

If the calculated variation is smaller than the reference value, it is determined that the brightness value of the corresponding region is uniform and a bi-linear interpolation is performed using the motion vectors of the corresponding block.

If the calculated correlation between the block motion vectors is larger than the reference value, it is determined that there is a motion boundary in the corresponding region and a bi-linear interpolation is performed using the motion vectors of the corresponding block.

The blocks adjacent to the current pixel are four blocks adjacent to the pixel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a motion vector estimation method according to the prior art;

FIG. 2 illustrates a method of spatially interpolating motion vector in pixel unit according to the prior art;

FIG. 3 illustrates a motion vector estimation method centered on a picture to be interpolated according to the present invention;

FIG. 4A illustrates a motion vector estimation method when a component of motion vector is even;

FIG. 4B illustrates a motion vector estimation method when a component of motion vector is odd;

FIG. 5 is a flowchart illustrating a method of spatially interpolating a motion vector according to the present invention; and

FIGS. 6A and 6B illustrate methods of spatially interpolating motion vector.

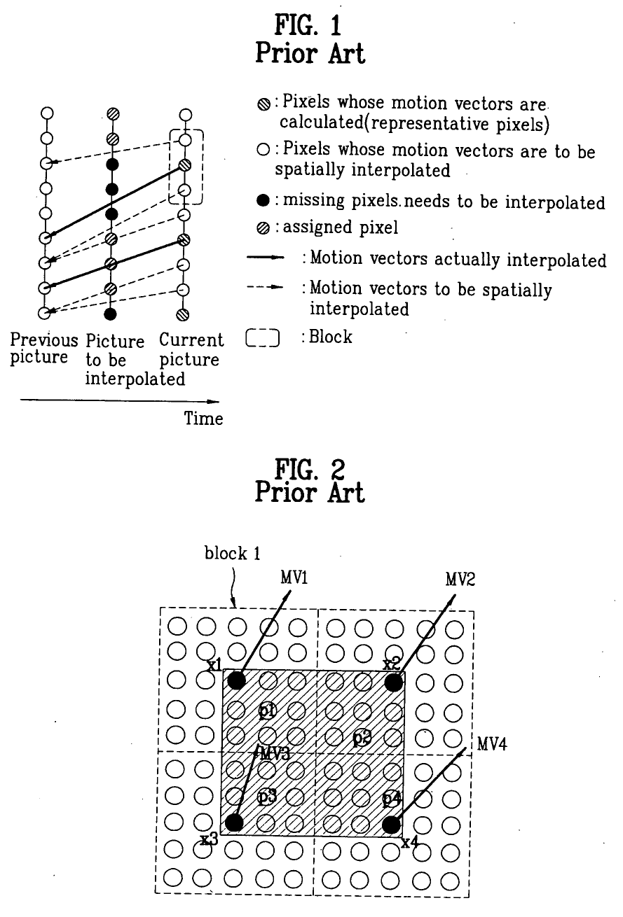

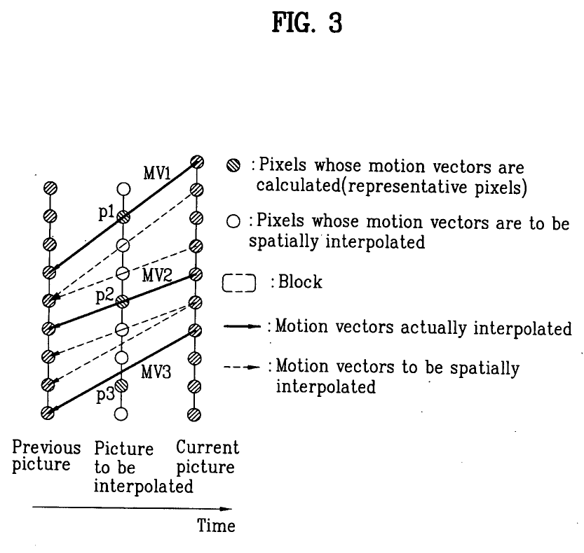

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A motion vector estimation and interpolation method of converting frame rate according to the preferred embodiments of the present invention will be described below in detail with reference to the accompanying drawings.

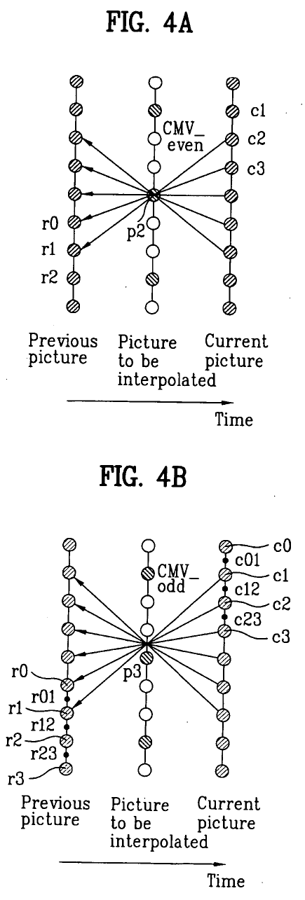

FIG. 3 illustrates a motion vector estimation method centered on a picture to be interpolated according to the present invention.

The present invention provides a motion vector estimation and interpolation method of converting frame rate, which is adapted to convert an arbitrary video signal into a video signal having higher frame rate than the arbitrary video signal.

For this purpose, the present invention uses a method of estimating motion vector centered on a picture to be interpolated so as to prevent missing pixels from occurring on the picture to be interpolated. Further, in addition to adjacent block motion vectors, brightness values of adjacent pixels are simultaneously considered so as to spatially interpolate motion vector of pixel.

First, the block motion vector estimation according to the present invention will be described below.

In FIG. 3, the motion vector estimation method centered on the picture to be interpolated is illustrated. For convenience of explanation, only one axis of a two-dimensional video signal is illustrated and it is assumed that three pixels are contained in one block. Here, reference symbols p1, p2 and p3 denote a representative pixel of each block.

Referring to FIG. 3, a candidate motion vector (CMV) passing through a representative pixel of a picture to be interpolated is selected and blocks (for example, a pixel p2 and pixels disposed at upper and lower positions thereof) are made centered on a pixel where the candidate motion vector meets a current picture and a previous picture. Then, a difference between brightness values of pixels corresponding to the blocks is calculated.

A candidate motion vector where the difference is minimized is assigned as a motion vector value of a block of a picture to be interpolated.

An arrow indicated by a solid line represents a motion vector that is actually estimated, and an arrow indicated by a dotted line represents a motion vector that is spatially interpolated.

The candidate motion vector can be classified into an even component and an odd component.

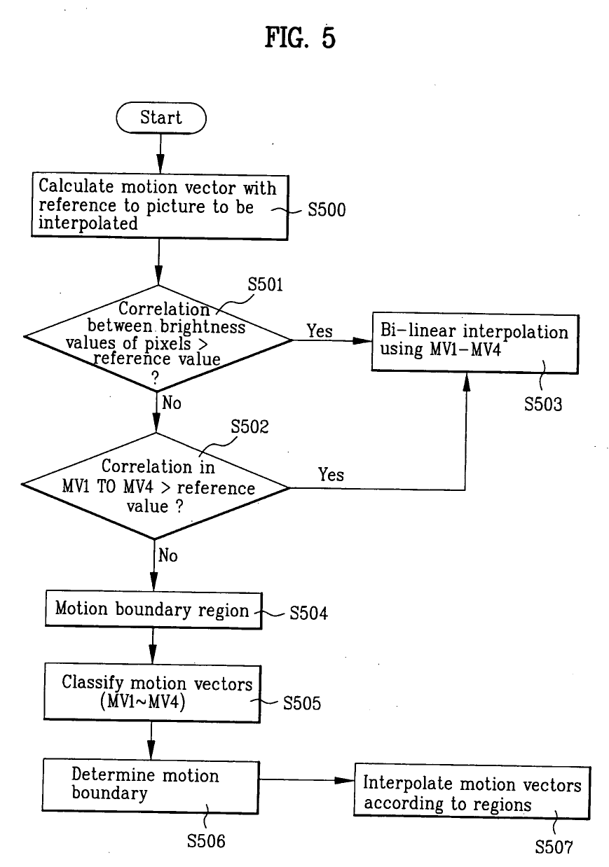

FIG. 4A illustrates a motion vector estimation method when a component of the motion vector is even and FIG. 4B illustrates a motion vector estimation method when a component of the motion vector is odd.

In FIG. 4A, it is assumed that components of candidate motion vectors in the representative pixel p2 are even. A candidate motion vector CMV symmetrical to a previous picture and a current picture centered on the representative pixel p2 is found. Then, a difference in brightness values of blocks of the previous picture and the current picture made by the candidate motion vector is calculated using Eq. 1 below.
Error(CMV_even)=(|c2−r1|+|c1−r2|+|c3−r0|) (Eq. 1)

That is, a difference value Error(CMV_even) of each block brightness in the previous picture and the current picture is calculated by summing an absolute value of subtraction between a pixel value c2 of the current picture and a pixel value r1 of the previous picture, an absolute value of subtraction between a pixel value c1 and a pixel value r2 of the previous picture, and an absolute value of subtraction between a pixel value c3 of the current picture and a pixel value r0 of the previous picture.

FIG. 4B illustrates a motion vector estimation method when a component of the motion vector is odd.

Referring to FIG. 4B, if a component of a candidate motion vector passing through the representative pixel p3 is odd, a path of the candidate motion vector does not pass through the representative pixel p2 actually.

In that case, the candidate motion vector is shifted downward or upward by half pixel so that it can pass through the representative pixel p3. After values between the pixels are linearly interpolated by using adjacent pixels, blocks are made. Then, a difference in brightness values of blocks of a current picture and a previous picture is calculated.

For example, when the candidate motion vector is CMV_odd, values c01, c12 and c23 are respectively made by using pixel values c0 and c1, pixel values c1 and c2, and pixel values c2 and c3. These values are assigned to blocks of the current picture.

Likewise, values r01, r12 and r23 are respectively made by using pixel values r0 and r1, pixel values r1 and r2, and pixel values r2 and r3. These values are assigned to blocks of the previous picture. A difference in brightness values of a block corresponding to CMV_odd is calculated using Eq. 2 below.
Error(CMV_odd)=(|c01−r01|+|c12−r12|+c23−r23|) (Eq. 2)

In this manner, a difference in brightness values of blocks of the corresponding current and previous pictures with respect to all candidate motion vectors is calculated. A candidate motion vector where the difference is minimized is assigned as a motion vector of a representative pixel of the block.

Next, a method of spatially interpolating a pixel-based motion vector from a motion vector that is estimated based on block unit as shown in FIGS. 4A and 4B will be described below.

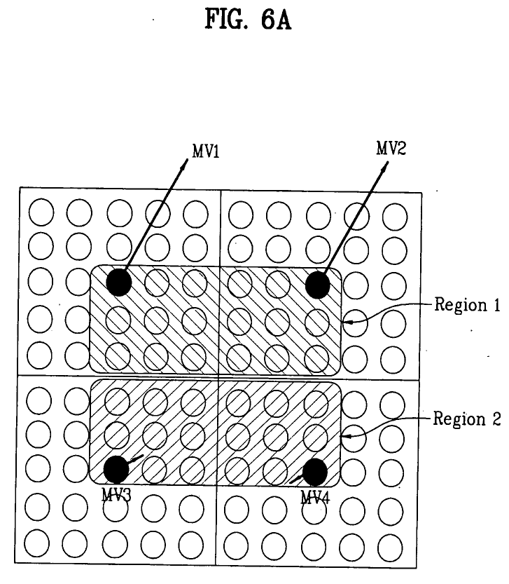

FIG. 5 is a flowchart illustrating a method of spatially interpolating a motion vector according to the present invention.

Since a correlation between motion vectors of representative pixels of the blocks is high at a region that is not a motion boundary, motion vectors of pixels are calculated using a method of bi-linearly interpolating the adjacent block motion vectors.

However, in the case of pixels existing at motion boundary, motions in motion vectors of representative pixels of simply adjacent blocks are also estimated to be different from each other. Therefore, if the bi-linear interpolation is performed only using them, a blurring of the interpolated motion vector may occur in the pixels.

A blurring phenomenon in the brightness value may be caused even at the temporally interpolated picture.

Accordingly, after determining whether the current pixel is placed at the motion boundary, a method of interpolating motion vector of a pixel is differently selected according to the determined result.

In order to determine whether the current pixel is placed at the motion boundary, magnitudes and directions of motion vectors in four representative pixels adjacent to the pixel and variance of brightness values in blocks containing the representative pixels are used.

That is, as shown in FIGS. 4A and 4B, motion vector is calculated centered on the picture to be interpolated so as to spatially interpolate motion vector in the pixels (the pixels contained in the region indicated by the oblique lines) existing among the regions x1 to x4 constituting unit blocks where the motion vector estimation is performed (S500).

A correlation between the brightness values of the pixels is calculated (S501). In other words, a variation of the brightness values in the regions x1 to x4 constituting the unit blocks is calculated.

If the calculated correlation is larger than a reference value, it can be considered that the corresponding region has uniform brightness value. Since the region is not included in the motion boundary, the motion vectors of the pixels contained in the region is bi-linearly interpolated using the motion vectors MV1 to MV4 (S503). That is, if the variation of the brightness values in the regions x1 to x4 is smaller than a reference value, it can be considered that the corresponding region has uniform brightness value, so that the bi-linear interpolation is performed.

If the calculated correlation is smaller than the reference value, the corresponding region may be included in the motion boundary. Therefore, the correlation in the motion vectors MV1 to MV4 is calculated so as to determine whether the region is included in the motion boundary (S502).

If the four motion vectors have somewhat constant correlation in magnitudes and directions, it is judged that there is no motion boundary in the region and the motion vectors MV1 to MV4 are bi-linearly interpolated. In this manner, motion vectors of the pixels contained in the corresponding region are interpolated.

If the correlation in the four block motion vectors is low, it is judged that there is the motion boundary in the corresponding region (S504), and the block motion vectors are classified according to magnitudes and directions (S505).

Motion boundary is determined by dividing pixels whose motion vectors are to be spatially interpolated into several regions by using the classified block motion vectors (S506), and the motion vectors are interpolated independently according to the regions (S507).

Here, there are two cases in the classification of the motion vectors. One is a case where the motion vectors are correlated two by two, and the other is a case where the motion vectors are correlated three by three.

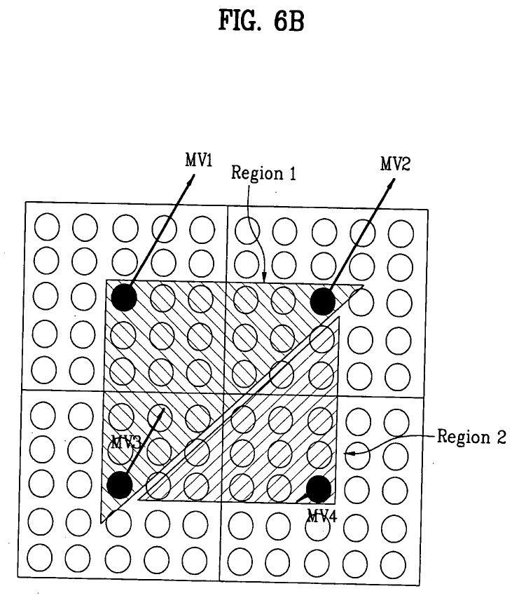

FIGS. 6A and 6B illustrate methods of spatially interpolating motion vector.

FIG. 6A illustrates a case where the block motion vectors are similar two by two. In region 1, the first and second motion vectors MV1 and MV2 are similar to each other. In region 2, the third and fourth motion vectors MV3 and MV4 are similar to each other.

In FIG. 6A, it can be seen that the boundary of the brightness value, that is, the motion boundary, exists horizontally among the pixels whose motion vectors are to be interpolated. Accordingly, horizontal edge component (the horizontal edge is placed at the middle in FIG. 6A) is found and the pixels are divided into the region I and the region 2 with reference to the horizontal edge component.

The pixels contained in the region I are interpolated using the first and second motion vectors MV1 and MV2, and the pixels contained in the region 2 are interpolated using the third and fourth motion vectors MV3 and MV4.

FIG. 6B illustrates a case where the block motion vectors are similar three by three. The boundary of the brightness value exists in 45° direction among the pixels whose motion vectors are to be interpolated.

Accordingly, edge component of the 45° direction is found and the pixels are divided into the region 1 and the region 2 with reference to the edge component. The pixels contained in the region 1 are interpolated using the first to third motion vectors MV1 to MV3, and the pixels contained in the region 2 are interpolated using the fourth motion vector MV4.

The method of converting the frame rate based on the motion compensation according to the present invention is adapted to convert an arbitrary video signal into a video signal having higher frame rate than the arbitrary video signal. In order to prevent the occurrence of the missing pixels, the motion vectors are estimated with reference to the picture to be interpolated, and the brightness values as well as the adjacent block motion vectors are considered so as to spatially interpolate the motion vectors of the pixels.

When converting the frame rate among various kinds of video signals, especially when an arbitrary video signal is converted into a video signal having higher vertical frequency than the arbitrary signal, the present invention can be effectively applied to the motion vector estimation required for making new field or frame from adjacent two fields or frames

It will be apparent to those skilled in the art that various modifications and variations can be made in the present invention. Thus, it is intended that the present invention covers the modifications and variations of this invention provided they come within the scope of the appended claims and their equivalents.

1. A method of converting frame rate of video signal based on motion compensation, comprising the steps of:
estimating a plurality of motion vectors based on block unit with reference to a picture to be interpolated; and
if a current pixel exists in a motion boundary according to a correlation between brightness values of pixels with respect to motion vectors based on pixel unit, classifying and interpolating the plurality of estimated motion vectors based on the block unit according to motion boundary regions.

2. The method of claim 1, wherein the estimation of the plurality of motion vectors based on the block unit comprises the steps of:
selecting a candidate motion vector (CMV) passing through a representative pixel of the picture to be interpolated;
making blocks centered on pixels where the candidate motion vector meets a current picture and a previous picture with reference to one axis of a two-dimensional video signal;
calculating a difference in brightness values of pixels corresponding to the blocks; and
assigning a candidate motion vector where the calculated difference is minimized as a block motion vector of the picture to be interpolated.

3. The method of claim 2, wherein if a component of the candidate motion vector (CMV) is even, the calculation of the difference in the brightness values of the pixels comprises the steps of:
finding a candidate motion vector symmetrical to each other in the previous picture and the current picture with reference to a representative pixel of a corresponding block; and
suming absolute values of the difference values of the pixels constituting the corresponding block.

4. The method of claim 2, wherein if a component of the candidate motion vector (CMV) is odd, the calculation of the difference in the brightness values of the pixels comprises the steps of:
shifting a path of a candidate motion vector that does not pass through the representative pixel so as to make the candidate motion vector pass through the representative pixel;
making blocks by linearly interpolating values between each pixels using adjacent pixels; and
calculating a difference in brightness values of blocks of the current picture and the previous picture.

5. The method of claim 4, wherein the candidate motion vector is shifted by half pixel from the axis so as to make the candidate motion vector pass through the representative pixel.

6. The method of claim 1, wherein if the correlation between the brightness values is larger than a reference value, it is determined that the brightness value of the corresponding region is uniform and a bi-linear interpolation is performed using motion vectors of the corresponding block.

7. The method of claim 1, wherein if the correlation value between the brightness values is smaller than a reference value, a correlation between a plurality of motion vectors is calculated, and if the calculated correlation is larger than the reference value, it is determined that a brightness value of the corresponding region is uniform and a bi-linear interpolation is performed using motion vectors of the corresponding block.

8. The method of claim 7, wherein if the calculated correlation is smaller than the reference value, the plurality of motion vectors are classified according to the motion boundary regions.

9. The method of claim 8, wherein in the classification of the plurality of motion vectors, the block motion vectors are classified based on magnitudes and directions.

10. The method of claim 9, further comprising the steps of:
determining the motion boundary after classifying the block motion vectors according to the motion boundary regions, based on the magnitudes and directions; and
interpolating the motion vectors independently according to the determined motion boundary regions.

11. A method of converting frame rate based on motion compensation, comprising the steps of:
calculating a variation of brightness values in pixels including representative pixels of blocks adjacent to a current pixel;
if the calculated variation is larger than a reference value, calculating a correlation of block motion vectors in magnitudes and directions;
if it is determined that there is a motion boundary in a corresponding region by the calculated correlation between the block motion vectors, classifying the block motion vectors in magnitudes and directions; and
determining the motion boundary of the classified motion vectors and interpolating the motion vectors according to the corresponding region.

12. The method of claim 11, wherein if the calculated variation is smaller than the reference value, it is determined that the brightness value of the corresponding region is uniform and a bi-linear interpolation is performed using the motion vectors of the corresponding block.

13. The method of claim 11, wherein if the calculated correlation between the block motion vectors is larger than the reference value, it is determined that there is a motion boundary in the corresponding region and a bi-linear interpolation is performed using the motion vectors of the corresponding block.

14. The method of claim 11, wherein the blocks adjacent to the current pixel are four blocks adjacent to the pixel.
